(19) United States
(12) Patent Application Publication
(10) Pub. No.: US 2018/0247376 A1
(43) Pub. Date: Aug. 30, 2018

(54) AUTOMATED TRANSACTION VALIDATION WITH DISTRIBUTED LEDGER

(71) Applicant: HealthshareBlox, LLC, Alpharetta, GA (US)

(72) Inventors: Rahul Sharma, Cumming, GA (US); Lynn Eliot Carroll, Atlanta, GA (US); Deepti Sharma, Cumming, GA (US); Navneet Verma, Marietta, GA (US)

(21) Appl. No.: 15/906,651

(22) Filed: Feb. 27, 2018

Related U.S. Application Data
(60) Provisional application No. 62/463,829, filed on Feb. 27, 2017.

(51) Int. Cl. G06Q 40/08; G06Q 40/02; G06Q 20/24; G06F 17/30; G06F 17/27

(52) U.S. Cl. CPC G06Q 40/08; G06Q 40/025; G06F 17/2705; G06F 17/30283; G06Q 20/24

(57) ABSTRACT

A system and method for validating claims using an distributed ledger. An electronic claim data file is received from a provider computer client. The electronic claim data file is parsed to determine a claim transaction. The claim transaction is scored. The claim transaction is written to the distributed ledger. A smart contract data file is received from a lender computer client. The smart contract data file includes a smart contract associating the claim transaction with a loan transaction. The smart contract is written to the distributed ledger. The smart contract associating the claim transaction and the loan transaction is executed.

### CROSS-REFERENCE TO RELATED APPLICATION(S)

This application claims priority to U.S. Provisional Patent Application Ser. No. 62/463,829, filed Feb. 27, 2017, which is hereby incorporated herein by reference in its entirety.

### TECHNICAL FIELD

The present disclosure relates to transaction validation systems, and more particularly to automated claim validation systems using distributed ledger technology.

### BACKGROUND

The healthcare ecosystem in the United States presents an economic environment that is uniquely complex. The service-to-payment cycle for healthcare service providers is burdened with regulation, multifaceted contractual nuances, third party payers, paper-based processes, and technical system inefficiencies. This setting creates numerous challenges for healthcare service providers, including the management of daily operations and the timing of payment received for services performed.

For example, typically healthcare provider bills a third-party payer, such as a health insurance company, for services that are rendered to a patient. The health insurance company receives the bill and processes the bill to ensure that the services rendered were performed within the guidelines set forth in any contracts between the parties. In some cases, the amount billed may be reduced, denied, or challenged, requiring further information exchange between the parties. Delays of weeks or months are not uncommon from the time a health insurance company receives a bill and pays the health service provider. Similar dynamics exist in other industries, including other forms of insurance.

Although health service providers may employ traditional lines of credit to deal with any cash flow issues that may arise from delays in receiving payment, such lines of credit may not be available at favorable rates, if at all, and may not account for changes in the flow of payments due to delays at different health care providers. As such, a need exists for enhanced techniques for automating claim validation in healthcare and related fields.

### SUMMARY

In one embodiment, method for processing and/or validating claims using an distributed ledger is presented. An electronic claim data file is received from a provider computer client. The electronic claim data file is parsed to determine a claim transaction. The claim transaction is scored. The claim transaction is written to the distributed ledger. A smart contract data file is received from a lender computer client. The smart contract data file includes a smart contract associating the claim transaction with a loan transaction. The smart contract associating the claim transaction and the loan transaction is written to the distributed ledger. The smart contract associating the claim transaction and the loan transaction.

In another embodiment, an automated claim validation system including an distributed ledger is presented. The system includes a provider computer client, a lender computer client, and a payer computer client, all with access to the distributed ledger. The system further includes a claim validation server. The claim validation server includes a processor programmed to perform the steps of a method. An electronic claim data file is received from a provider computer client. The electronic claim data file is parsed to determine a claim transaction. The claim transaction is scored. The claim transaction is written to the distributed ledger. A smart contract data file is received from a lender computer client. The smart contract data file includes a smart contract associating the claim transaction with a loan transaction. The smart contract associating the claim transaction and the loan transaction is written to the distributed ledger. The smart contract associating the claim transaction and the loan transaction.

### BRIEF DESCRIPTION OF THE SEVERAL VIEWS OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIGS. 1A-1B are high-level diagrams showing the components of an embodiment of a system for automated claim validation;

FIG. 2 is a flow diagram of a method for validating claims using an distributed ledger.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The present disclosure relates to automated claim validation, for instance between healthcare providers and payers such as insurance companies. The techniques set forth herein advantageously allow for participation in a payment market by third-party lenders. By way of overview, multiple healthcare providers, payers (e.g., insurance companies) and lenders (e.g., financial institutions) may participate in an ecosystem using the technological features set forth herein. Advantageously, the secure, automated claim validation infrastructure described below allows for these participants to automate participation in the ecosystem without risk. Risk is mitigated due to the use of distributed ledger technology, including blockchain technology. A distributed ledger, also called a shared ledger, or referred to as distributed ledger technology, is, in one example, a consensus of replicated, shared, and synchronized digital data geographically spread across multiple sites, countries, or institutions. One form of distributed ledger design is the blockchain system, which can be either public or private. But not all distributed ledgers have to necessarily employ a chain of blocks to successfully provide secure and valid achievement of distributed consensus, and thus a blockchain is only one type of data structure considered to be a distributed ledger.

As another advantage, the system disclosed herein addresses the cash flow needs of healthcare service providers via machine-automated algorithms that are applied to medical claims or invoices that submitted for healthcare services covered by third party payers. Using smart contracts and proprietary application programming interface (API) software, a distributed ledger is used so that each party may be assured of the accuracy of transactions.

As a further advantage, the present disclosure allows an integration of claim parsing, claim scoring, distributed ledger and smart contract execution in a single, trusted server. By combining these different functions, all of the functions can be processed in a manner that ensures trust between counterparties that engage in the system. For example, traditional claim scoring methodologies have occurred within the provider network alone, or within a payer network alone. In such a case, neither the provider nor the payer trusts the scoring performed by the other party, as such trust could be prone to abuse. Instead, each party performs local scoring on local data stored local to their computer client only. By integrating the parsing and scoring functionality with the distributed ledger technology, in addition to smart contract execution, the system can automate the scoring of claims necessary for each party to ascribe value to the claim, and allows for an advancement of automated claim transaction processing technology.

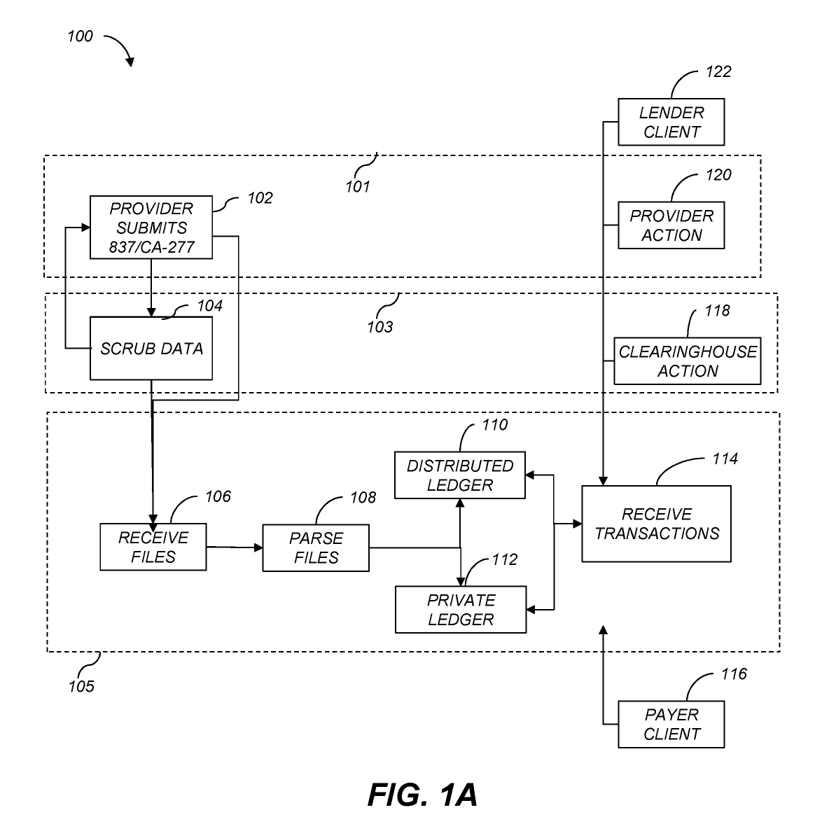

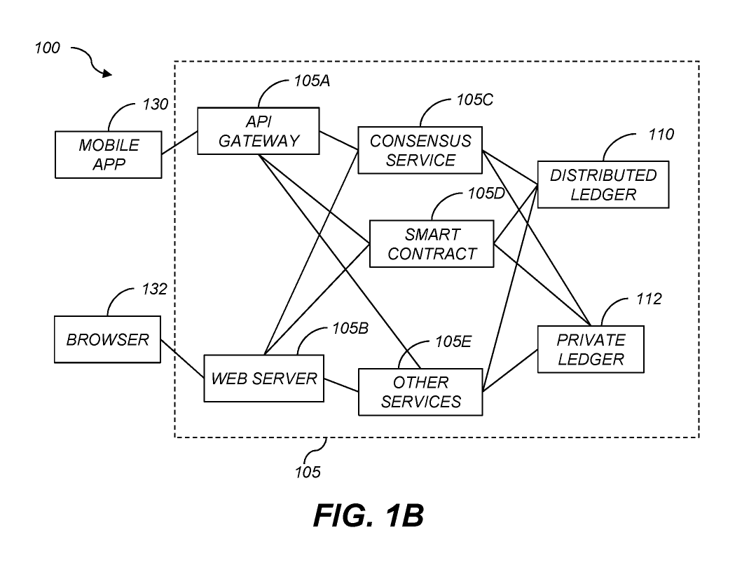

FIGS. 1A and 1B describe an example claim validation system 100, in accordance with one or more aspects set forth herein. For example, the claim validation system 100 may include a claim validation server 105, which performs a variety of functions, and may operate on a computer server system having a database, web server, and input/output systems. In addition, also depicted are a provider computer client 101, a clearinghouse computer client 103, a payer computer client 116 and a lender computer client 122.

The different computer clients 101, 103, 116, 122 may access a distributed ledger that is managed, for example, by the claim validation server 105. These different computer clients 101, 103, 116 and 122 are controlled by different parties that are involved in, for example, the medical claim process. Other computer clients may be provisioned for different entities, including also regulators or auditors. Furthermore, the system 105 may support numerous of each type of entity, for example hundreds of provider computer clients 101, hundreds of payer computer clients 116, etc.

Beginning with block 102, a provider sends ANSI 837 or CA-277 medical billing record data files to a clearinghouse computer client 103. At block 104, the clearinghouse computer client receives the medical data files, for example using a secure file transfer protocol (FTP) server, and scrubs the files to ensure that the data is properly formatted. Next, the claim validation server 105 at block 106 receives the scrubbed data files from the clearinghouse computer client 103 or directly from the provider computer client. In such a case, once the files are uploaded to the claim validation server 105, at block 108 the claim validation server 105 uses API software to parse, pick up and processes the data files. Besides parsing of the file and checking for rules pertaining to the different loops and segments within the data file, the API ascertains what data elements will get written to the distributed ledger 110 and what will be stored on the private ledger at block 112. The data that is stored on the distributed ledger 110 goes through a smart contract execution process to ensure that the data written to the distributed ledger 110 and shared (in whole or in part) with the other members, including the lender computer client 122, passes all the required processing rules agreed to between the members. As one advantage, the processing reduces back and forth processing as well as a need for cumbersome reconciliation processing of the data, or integration between separate systems and the helps mitigate the data redundancy issues by establishing a golden record for the data. Although ANSI 837 and CA-277 are example formats that may be used, other formats are equally supported by the system, for example EDI formats used in other industries.

Turning next to FIG. 1B, the claim validation server 105 may communicate with mobile applications 130 and web browser applications 132. In each case, the applications may have both an Administration view as well as end user(s) view which is controlled via roles/permissions set up. The claim validation server 105 may use an API gateway 105A to communicate with mobile applications 130, and a web server 105B to communicate with the browser applications 132.

Because the claim validation server 105 controls a distributed ledger 110, only members with appropriate permissions may access the system to write to the distributed ledger 110. When a new record is added, the ledger's integrity is checked by a limited consensus process, e.g., at block 105C. This is carried out by a set of API and smart contracts code that resides on the claim validation server 105. In one example, permissioned distributed ledger technology provides highly-verifiable data sets because the consensus process creates a digital signature which can be seen by all members, e.g., through all the connected computer clients. Smart contracts at block 105D, which are written to the distributed ledger 110 by the claim validation server 105, are contracts whose terms are recorded in a computer language instead of legal language and they are made to execute as the data is written to the ledger by any of the member nodes via the corresponding computer client.

In another embodiment, each computer client, such as computer clients 101, 103, 116, 122 houses a local copy of the distributed ledger 110. Each local copy can contain a sub-set of the data or the whole data-set or just a summary information set. In addition, a private ledger 112 data storage may be employed on a per client basis by the claim validation server 105 to store information which provides value added services to the network participants but that data does not need to be on the on the ledger since it does not need to be shared with more than one member computer client and/or it requires further processing like a rule based engine or a machine learning algorithm to add value to the data before it is presented to the member(s).

The claim validation server 105 may include a set of APIs accessible to the computer clients 101, 103, 116, 122 through which the members can access and submit the claims data for processing on the DLT. These APIs parse the submitted files and apply the rules at runtime to ascertain which data-set goes to the distributed ledger 110 and what gets stored to the private ledger 112. Once the data is written to the distributed ledger 110, smart contract(s) are executed at block 105D, are assigned and signed by the relevant parties. In one example, only signed transactions are stored locally on the originating node and then broadcast to other parties, such as computer clients 101, 103, 116, 122, depending on their roles, permissions and the data-set that computer clients 101, 103, 116, 122 can see. The distributed ledger 110 data is immutable i.e. once written, it cannot be changed. Advantageously, the use of both distributed ledger 110 and private ledger 112 allow the presentation of value added services to the members in the network as well as to the third-party vendors who can get value added services in the form of data APIs.

In one embodiment, the claim validation server 105 allows multiple overlapping systems to be synchronized with each other, because the claim validation server 105 may parse numerous different claim data file formats.

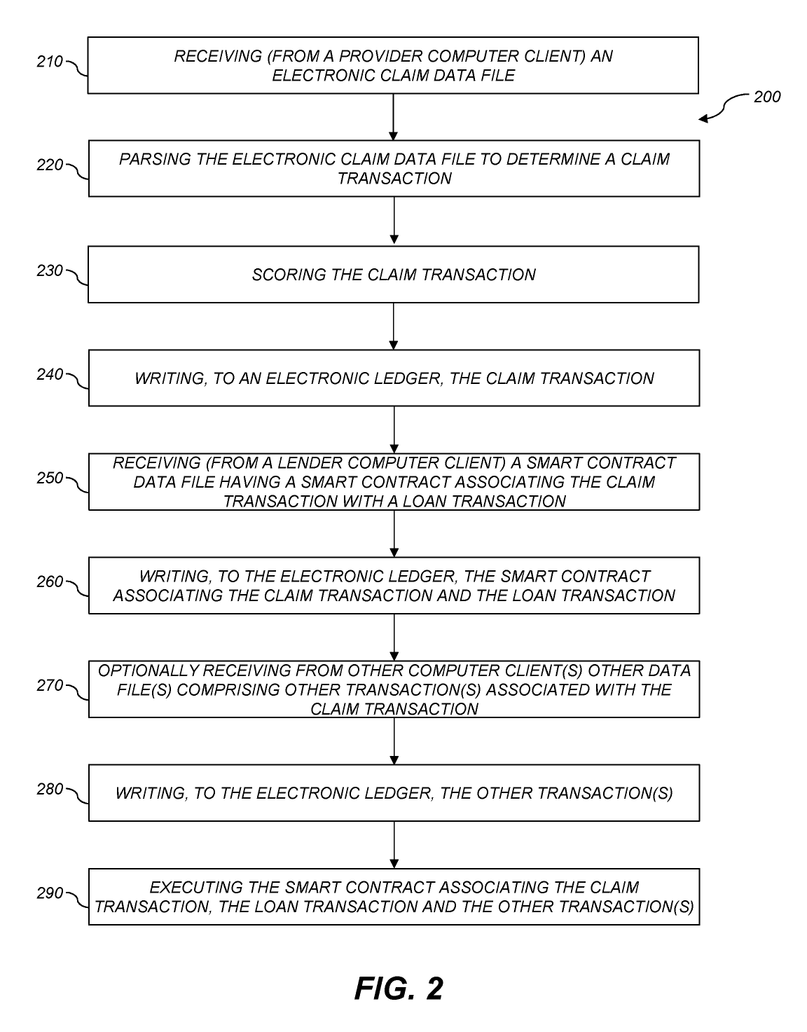

FIG. 2 is a flow diagram of an embodiment of a method 200 for validating or processing claims using an distributed ledger. In one embodiment, the method 200 may execute on a claim validation server, such as the claim validation server 105 (FIG. 1A).

For instance, the method 200 at block 210 may receive an electronic claim data file from a provider computer client. In one example, the data file(s) may be received using a secure file transfer protocol.

Next, the method 200 at block 220 may parse the electronic claim data file to determine a claim transaction. The electronic claim data file may be in one of the formats discussed above, such as ANSI CA-277 or 837, and the method 200 at block 220 can read the file format and decode the relevant claim data. Then, the claim data can be parsed at block 230 to determine a plurality of claim transactions that may be present in the claim data file.

Next, the method 200 at block 230 may score the claim transaction. By way of example, the medical claims data may be evaluated using applied statistical methods to substantiate and score medical claims for the purpose of accelerating payment to providers from third party funding sources (insurers, banks, and other financial services businesses). Advantageously, this approach to the management of medical claims alleviates the challenges associated with an oftentimes unpredictable service-to-payment cycle for healthcare service providers, aligns working capital to the provision of services, and removes the burden of uncertainty with respect to the payment of medical claims. The system described herein may also be used in other industries, including other types of insurance, online sales, and any other system in which third-parties are involved in the payment for services consumed by consumers.

In one example of scoring at block 230, the data is processed by applying statistical methods to score the medical claims for the purposes of providing a predictable score to the claims which helps the financial institutions to accelerate the process of deploying capital to the providers. These algorithmic processes also help the providers by giving them visibility into what are the common issues with their claims and how they can address them which in turn will help them to keep the coding/billing issues to a minimum and hence get paid faster.

With the increased data volume, machine learning algorithms are used to forecast claim rejection rates, and chance of capital approval. For instance, the claim validation server can keep track of the approval percentages by billing code, and use that information to develop a probability heuristic demonstrating the chance that the insurance company will pay the claim. In such a case, the risks as well as the likelihood of getting a loan processed by the insurance company may be listed per claim. Further data analysis capabilities are provided based on additional attributes in the claims file to help mitigate coding/billing errors for the providers and to get the capital deployed quickly for the providers. In addition, machine learning algorithms are used to forecast claim rejection rates, and chance of capital approval.

As an advantage, usage of statistical algorithms and machine learning code to rank and score the medical claims hence facilitating faster claim settlements and payment processes. For example, scoring the claim transaction can include determining the probability of the claim transaction being approved as submitted, or can allow a lender to determine a discounted value to lend the provider based on the claim.

In addition, the scoring can include determination of procedure to procedure rules, medically unlikely edits, etc. Specifically, the scoring can determine adherence to claims guidelines as set forth by the U.S. Centers for Medicare & Medicaid Services, including the “National Correct Coding Initiative Policy Manual, Effective Jan. 1, 2017,” and the “Medically Unlikely Edits File,” each of which is hereby incorporated herein in its entirety.

In another example, the scoring may be based on historical data obtained during previous scoring as compared to actual payment rates for the same transaction. Such information may be incorporated using machine learning techniques so that past performance may be used to predict future behavior by payers (e.g., insurance companies).

Next, the method 200 at block 240 may write, to the distributed ledger, the claim transaction, which publishes the claim transaction so that all other parties may see that a claim transaction is available, for example, for lending against.

In one embodiment, the method 200 at block 250 may receive a smart contract data file from a lender computer client, for example, from a lender that wishes to loan a certain percentage of the value of the claim transaction. The smart contract data file can include a smart contract associating the claim transaction with a loan transaction. Optionally, in another embodiment, the smart contract can also be associated with a payment transaction. For instance, a claim transaction in the amount of $1,000 with a score of 50% probability of being paid may lead to a lender offering a contract to immediately pay the provider $500, in return for ownership of the first $500+interest received from a payer for that claim transaction. In addition, a second contract data file from a second lender computer client may offer $510 for the same claim transaction, in return for a payment of principal and interest. In such a case, the provider computer client can be used to sign one of these two contracts, depending on which is more advantageous to the provider at the given moment.

Next, the method 200 at block 260 may write, to the distributed ledger, the smart contract associating the claim transaction and the loan transaction. Thus, the transaction is memorialized, and the claim transaction, and an advance loan by the lender are all linked together so that there is no unknown risk to any of the parties regarding the transaction. In addition, the claim validation server 105 continues writing numerous other transactions to the distributed ledger. In another embodiment, any payment received from the payer (e.g., insurance company) may also be written to the distributed ledger.

In one example, at some later date, the payer (e.g., insurance company) may decide to pay the claim associated with the claim transaction, and the method 200 at block 270 may optionally receive one or more other data files from other computer clients having other transactions associated with the claim transaction, such as, in one example, a payment data file from a payer. Next, the method 200 at block 280 may write, to the distributed ledger, the other transaction. Then, the method 200 at block 290 may execute the smart contract, which associates the claim transaction with one or more other transactions. Because the smart contract execution is immutable, the system provides a guarantee to all parties that the contract execution only takes place upon commitments being received from all counterparties.

As an example, if the provider had previously accepted the $510 advance payment from the lender, then when the payer pays the payment, the claim validation server 105 will execute the other half of the smart contract at block 210 to ensure that the first $510+interest is paid to the lender. Any remaining amount may then be paid to the payer. Or, alternatively if the claim is denied in part or total, then the smart contract may indicate settlement requires a payment from the provider to the lender.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof “At least one of element A, element B, and element C” is not intended to be limited to at least one of an element A, at least one of an element B, and at least one of an element C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. An automated claim validation system including an distributed ledger, the system comprising:
a provider computer client with access to the distributed ledger;
a lender computer client with access to the distributed ledger; and
a claim validation server, the claim validation server comprising a processor programmed to:
receive an electronic claim data file from the provider computer client;
parse the electronic claim data file to determine a claim transaction;
score the claim transaction;
write, to the distributed ledger, the claim transaction;
receive a smart contract data file from the lender computer client, the smart contract data file comprising a smart contract associating the claim transaction with a loan transaction;
execute the smart contract associating the claim transaction and the loan transaction.

2. The automated claim validation system of claim 1, wherein the processor of the claim validation server is programmed to parse electronic claim data files having multiple payment file formats.

3. The automated claim validation system of claim 1, wherein the claim validation server comprises a secure file transport protocol server for receiving the electronic claim data file from the provider computer client and the smart contract data file.

4. The automated claim validation system of claim 1, wherein the processor of the claim validation server is further programmed to parse the electronic claim data file to determine a plurality of claim transactions, score the plurality of claim transactions and write the plurality of claim transactions to the distributed ledger.

5. The automated claim validation system of claim 1, further comprising a second lender computer client for sending a second contract data file to the claim validation server, wherein the processor of the claim validation server is further programmed to write a second smart contract to the distributed ledger, and wherein the provider computer client selects between the smart contract of the lender computer client and the second lender computer client.

6. The automated claim validation system of claim 1, wherein executing the smart contract comprises the claim validation server sending the loan transaction to the provider computer client.

7. The automated claim validation system of claim 1, wherein the processor of the claim processing server is further programmed to receive a payment transaction file from a payment computer client, associate the payment transaction file with the smart contract, and write the payment transaction to the distributed ledger.

8. The automated claim validation system of claim 1, wherein scoring the claim transaction comprises determining the probability of the claim transaction being approved as submitted.

9. The automated claim validation system of claim 1, wherein the claim validation server further manages a private distributed ledger for receiving claim transactions from the provider computer client.

10. The automated claim validation system of claim 1, wherein the claim validation server manages the distributed ledger.

11. A method for validating claims using an distributed ledger, the method comprising:
receiving an electronic claim data file from a provider computer client;
parsing the electronic claim data file to determine a claim transaction;
scoring the claim transaction;
writing, to the distributed ledger, the claim transaction;
receiving a smart contract data file from a lender computer client, the smart contract data file comprising a smart contract associating the claim transaction with a loan transaction; and
executing the smart contract associating the claim transaction and the loan transaction.

12. The method of claim 11, further comprising parsing electronic claim data files having multiple payment file formats.

13. The method of claim 11, further comprising receiving, using a secure file transfer protocol, the electronic claim data file from the provider computer client and the smart contract data file from the lender computer client.

14. The method of claim 11, wherein further comprising parsing the electronic claim data file to determine a plurality of claim transactions, score the plurality of claim transactions and write the plurality of claim transactions to the distributed ledger.

15. The method of claim 11, further comprising:
receiving a second contract data file from a second lender computer client, the second smart contract data file comprising a second smart contract associating the claim transaction with a second loan transaction;
writing a second smart contract to the distributed ledger; and
selecting between the smart contract of the lender computer client and the second lender computer client.

16. The method of claim 11, wherein executing the smart contract comprises:
sending the loan transaction to the provider computer client.

17. The method of claim 11, further comprising:
receiving a payment transaction file from a payment computer client;
associating the payment transaction file with the smart contract; and
writing the payment transaction to the distributed ledger.

18. The method of claim 11, wherein scoring the claim transaction comprises determining the probability of the claim transaction being approved as submitted.

19. The method of claim 11, further comprising managing a private distributed ledger for receiving claim transactions from the provider computer client.

20. The method of claim 11, further comprising managing the distributed ledger.
